(19) United States
(12) Patent Application Publication
(10) Pub. No.: US 2019/0243857 A1
(43) Pub. Date: Aug. 8, 2019

(54) JOINT DATA EVALUATION SYSTEM, JOINT DATA EVALUATION METHOD AND COMPUTER READABLE MEDIUM

(71) Applicant: D-Ocean, Inc., Tokyo (JP)

(72) Inventor: Teppei YAGIHASHI, Tokyo (JP)

(73) Assignee: D-Ocean, Inc.

(21) Appl. No.: 16/224,731

(22) Filed: Dec. 18, 2018

(30) Foreign Application Priority Data
Feb. 7, 2018 (JP) 2018-019989

(51) Int. Cl. G06F 16/95

(52) U.S. Cl. CPC G06F 16/95

(57) ABSTRACT

A distribution specifying unit (56) specifies a distribution of values of first attributes in a plurality of first type data segments included in a first data set. A distribution specifying unit (56) specifies a distribution of values of second attributes in a plurality of second type data segments included in a second data set. An evaluation data generating unit (60) generates evaluation data indicating an evaluation value of joining the first data set to the second data set based on the specified distribution of the values of the first attributes and the specified distribution of the values of the second attributes.

### CROSS-REFERENCE TO RELATED APPLICATION

The present application claims priority from Japanese application JP2018-019989 filed on Feb. 7, 2018, the content of which is hereby incorporated by reference into this application.

### BACKGROUND OF THE INVENTION

### 1. Field of the Invention

The present invention relates to a joint data evaluation system, a joint data evaluation method, and a computer readable medium.

### 2. Description of the Related Art

JP2014-146068A describes a data distribution system for enabling free bi-directional data distribution between businesses and facilitating the data distribution.

In the data distribution system described in JP2014-146068A, if the number of users involved in the data distribution, such as businesses in JP2014-146068A, or the amount of recorded data is increased, a user can hardly find desired data. This situation is not desirable for facilitating data distribution.

For example, if data which a user has is likely to present useful findings when joined with data which another user has, the data which another user has is likely the desired data for the user. As such, if the user can readily find the data which another user has, data distribution is expected to be facilitated.

Further, data is joined so as to previously generate data that is likely to present useful findings as described above, and thus the joined data can be conveniently accessed with light processing load and without performing joining process. The same goes for a case where data which a user has and data which another user has are joined and also a case where pieces of data which one user has are joined.

However, the techniques described in JP2014-146068A cannot evaluate joining data. As such, the techniques described in JP2014-146068A cannot provide data that is likely to present useful findings nor previously generate such data.

One or more embodiments of the present invention have been conceived in view of the above, and an object thereof is to provide a joint data evaluation system, a joint data evaluation method, and a computer readable medium capable of evaluating joining data.

### SUMMARY OF THE INVENTION

In order to solve the above described problems, a joint data evaluation system according to the present invention includes at least one processor, and at least one memory device that stores a plurality of instructions, which when executed by the at least one processor, cause the at least one processor to obtain a first data set including a plurality of first type data segments, each of the first type data segments including a value of a first attribute, obtain a second data set including a plurality of second type data segments, each of the second type data segments including a value of a second attribute, specify a distribution of the values of the first attributes in the plurality of first type data segments included in the first data set, specify a distribution of the values of the second attributes in the plurality of second type data segments included in the second data set, generate evaluation data indicating an evaluation value of joining the first data set to the second data set based on the specified distribution of the values of the first attributes and the specified distribution of the values of the second attributes.

In one aspect of the present invention, the at least one memory device that stores the plurality of instructions further causes the at least one processor to calculate a first feature amount vector indicating a feature of the distribution of the values of the first attributes in the plurality of first type data segments included in the first data set, the second distribution specifying means calculates a second feature amount vector indicating a feature of the distribution of the values of the second attributes in the plurality of second type data segments included in the second data set, the evaluation data generating means generates evaluation data indicating an evaluation value of joining the first data set to the second data set based on the generated first feature amount vector and the generated second feature amount vector.

In one aspect of the present invention, the at least one memory device that stores the plurality of instructions further causes the at least one processor to obtain the first data owned by a first user, and obtain the second data owned by a second user.

In this aspect, the at least one memory device that stores the plurality of instructions may further cause the at least one processor to present the second data set to the user who owns the first data set in a case where the evaluation value indicated by the generated evaluation data satisfies a predetermined condition

In one aspect of the present invention, the at least one memory device that stores the plurality of instructions further causes the at least one processor to generate a third data set by joining the first data set to the second data set in a case where the evaluation value indicated by the generated evaluation data satisfies a predetermined condition.

In one aspect of the present invention, the first data set is a first table that includes each of the plurality of first type data segments as a first type record, the first type record includes the value of the first attribute as a value of a first column in the first type record, the second data set is a second table that includes each of the plurality of second type data segments as a second type record, the second type record includes the value of the second attribute as a value of a second column in the second type record, and the at least one memory device that stores the plurality of instructions further causes the at least one processor to generate evaluation data indicating an evaluation value of generating a table in which the first table and the second table are joined by joining the first column to the second column.

A joint data evaluation method according to the present invention includes the steps of obtaining a first data set including a plurality of first type data segments, each of the first type data segments including a value of a first attribute, obtaining a second data set including a plurality of second type data segments, each of the second type data segments including a value of a second attribute, specifying a distribution of the values of the first attributes in the plurality of first type data segments included in the first data set, specifying a distribution of the values of the second attributes in the plurality of second type data segments included in the second data set, generating evaluation data indicating an evaluation value of joining the first data set to the second data set based on the specified distribution of the values of the first attributes and the specified distribution of the values of the second attributes.

A non-transitory computer readable medium according to the present invention stores a program for causing at least one processor to obtain a first data set including a plurality of first type data segments, each of the first type data segments including a value of a first attribute, obtain a second data set including a plurality of second type data segments, each of the second type data segments including a value of a second attribute, specify a distribution of the values of the first attributes in the plurality of first type data segments included in the first data set, specify a distribution of the values of the second attributes in the plurality of second type data segments included in the second data set, generate evaluation data indicating an evaluation value of joining the first data set to the second data set based on the specified distribution of the values of the first attributes and the specified distribution of the values of the second attributes.

### BRIEF DESCRIPTION OF THE DRAWINGS

FIG. 1 is a diagram illustrating an example of a computer network according to an embodiment of the present invention;

FIG. 2 is a diagram illustrating an example of a time-line screen;

FIG. 3 is a diagram illustrating an example of product master data;

FIG. 4 is a diagram illustrating an example of shop master data;

FIG. 5 is a diagram illustrating an example of sales transaction data;

FIG. 6 is a diagram illustrating an example of data structure of posting data;

FIG. 7 is a diagram illustrating an example of weather data;

FIG. 8 is a diagram illustrating an example of a list of data items;

FIG. 9 is a diagram illustrating an example of a query execution screen;

FIG. 10 is a functional block diagram showing an example of functions implemented in the joint data evaluation system according to an embodiment of the present invention;

FIG. 11 is a diagram illustrating an example of evaluation data;

FIG. 12 is a flow chart showing an example of processing executed in the joint data evaluation system according to an embodiment of the present invention; and

FIG. 13 is a flow chart showing an example of processing executed in the joint data evaluation system according to an embodiment of the present invention.

### DETAILED DESCRIPTION OF THE INVENTION

Embodiments of the present invention will be described below in detail with reference to the accompanying drawings.

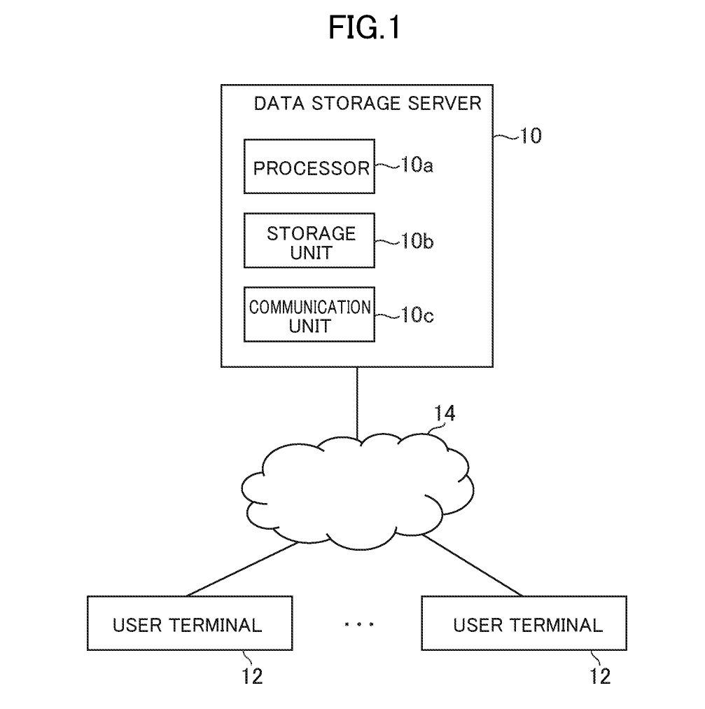

FIG. 1 is a diagram illustrating an example of a computer network 14 according to an embodiment of the present invention. As shown in FIG. 1, the computer network 14 according to this embodiment is connected to a data storage server 10 and a plurality of user terminals 12.

The data storage server 10 and the user terminal 12 are connected to the computer network 14, such as the Internet. As such, the data storage server 10 and the user terminals 12 can communicate with each other via the computer network 14.

In this embodiment, the user terminal 12 is a computer, such as a personal computer, a tablet terminal, and a smartphone. A web browser is installed in the user terminal 12 according to this embodiment.

In this embodiment, the data storage server 10 is a computer system including one or more server computers, for example. As shown in FIG. 1, the data storage server 10 includes, for example, a processor 10a, a storage unit 10b, and a communication unit 10c. The data storage server 10 may be, for example, a cloud system that provides a cloud service for supporting data distribution.

The processor 10a is, for example, a program control device such as a CPU that operates according to a program installed in the data storage server 10. The storage unit 10b is, for example, a storage element such as a ROM and a RAM, and a hard disk drive. The storage unit 10b stores, for example, programs executed by the processor 10a. The communication unit 10c is a communication interface, such as a network board and a wireless LAN module.

The data storage server 10 according to this embodiment stores data which each of a plurality of users owns. In this embodiment, the users access the data storage server 10 from their user terminals 12, and execute data processing and data analysis using their data or data which other users own. The user terminals 12 according to this embodiment are associated with different users. The user according to this embodiment may be an organization, such as a business, or an individual.

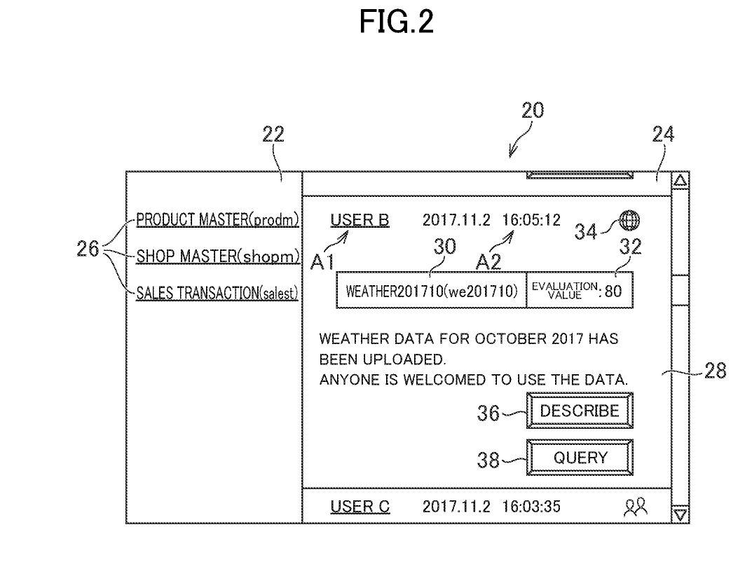

FIG. 2 is a diagram illustrating an example of a time-line screen 20 displayed on a display of a user terminal 12 according to this embodiment. The time-line screen 20 shown in FIG. 2 is displayed on, for example, a display of a user terminal 12 of a user A via a web browser.

As shown in FIG. 2, the time-line screen 20 according to this embodiment includes an index display area 22 and a time-line display area 24.

The index display area 22 includes, for example, a user-owned data index 26 associated with data which a user (e.g., user A) who uses a user terminal 12 owns.

Suppose that the user A has product master data, shop master data, and sales transaction data, for example. The data storage server 10 stores these pieces of data. In this case, as shown in FIG. 2, three user data indexes 26 respectively associated with these pieces of user-owned data are placed in the index display area 22. The user-owned data indexes 26 shown in FIG. 2 indicate names and alias names of data which the user owns. In the example of FIG. 2, the alias names of data are shown in parentheses. FIG. 2 shows a name of the product master data is ^{“}product master” and an alias name is “prodm.” FIG. 2 also shows a name of the shop master data is “shop master” and an alias name is “shopm.” FIG. 2 also shows a name of the sales transaction data is “sales transaction” and an alias name is “salest.”

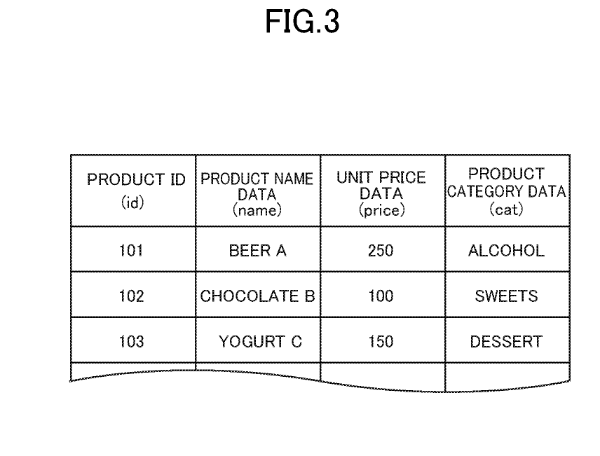

FIG. 3 is a diagram illustrating an example of the product master data. The product master data shown in FIG. 3 indicates three data segments. A data segment of the product master data according to this embodiment is associated with master information of a product. As shown in FIG. 3, a data segment of the product master data according to this embodiment includes four attribute values, i.e., a product ID, product name data segment price data, and product category data. In FIG. 3, alias names of the attributes are shown in parentheses. Specifically, for example, an alias name of the product name data in the product master data is indicated as “name.”

For example, identification information of a data segment is set as a value of a product ID of the data segment in the product master data. For example, a character string indicating a name of a product associated with the data segment is set as a value of the product name data in the data segment. For example, a value indicating a unit price of the product associated with the data segment is set as a value of the unit price data in the data segment. For example, a character string indicating a category of the product associated with the data segment is set as a value of the product category data in the data segment.

The product master data according to this embodiment may be a table including each of the data segments as a record. The records of the product master data according to this embodiment may include the values of the above-described four attributes as values of respective columns.

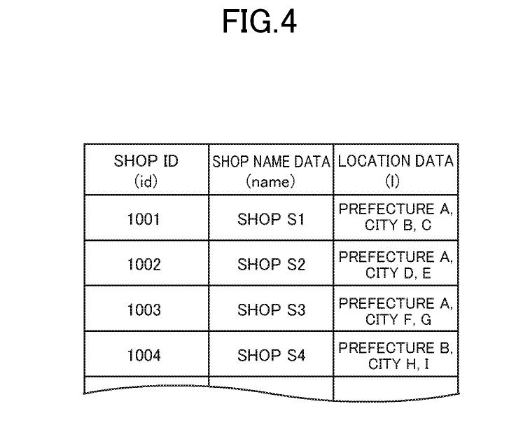

FIG. 4 is a diagram illustrating an example of the shop master data according to this embodiment. The shop master data shown in FIG. 4 indicates four data segments. A data segment of the shop master data according to this embodiment is associated with master information of a shop. As shown in FIG. 4, a data segment of the shop master data according to this embodiment includes three attribute values, i.e., a shop ID, shop name data, and location data. In FIG. 4, alias names of the attributes are shown in parentheses. Specifically, for example, an alias name of the location data in the shop master data is indicated as “1.”

For example, identification information of a data segment is set as a value of a shop ID of the data segment in the shop master data. For example, a character string indicating a name of a shop associated with the data segment is set as a value of the shop name data in the data segment. For example, a character string indicating a location of a shop associated with the data segment is set as a value of the location data in the data segment.

The shop master data according to this embodiment may be a table including each of the data segments as a record. The records of the shop master data according to this embodiment may include the values of the above-mentioned three attributes as values in respective columns.

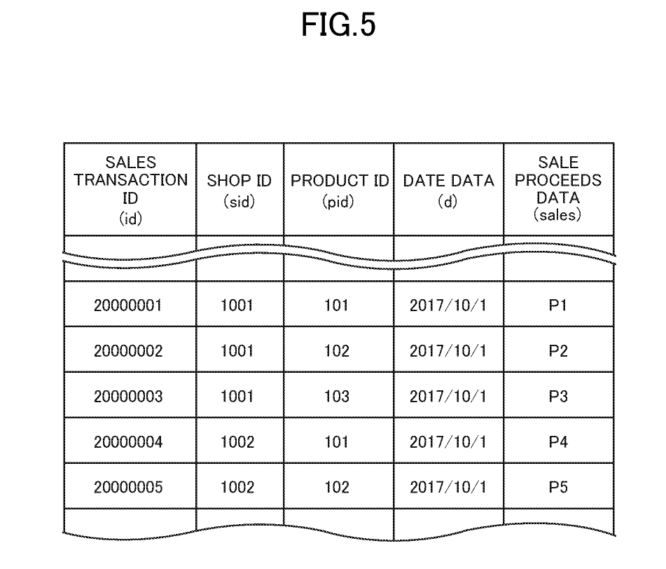

FIG. 5 is a diagram illustrating an example of the sales transaction data according to this embodiment. The sales transaction data shown in FIG. 5 indicates five data segments. A data segment of the sales transaction data according to this embodiment is associated with sales per day of a product in a shop. As shown in FIG. 5, a data segment of the sales transaction data according to this embodiment includes five attribute values, i.e., a sales transaction ID, a shop ID, a product ID, date data, and sale proceeds data. In FIG. 5, alias names of the attributes are shown in parentheses. Specifically, for example, an alias name of the sale proceeds data in the sales transaction data is indicated as “sales.”

For example, identification information of a data segment is set as a value of the sales transaction ID of the data segment in the sales transaction data. A shop ID of the shop associated with the data segment in the shop master data is set as a value of the shop ID of the data segment. For example, a product ID of the product associated with the data segment in the product master data is set as a value of the product ID in the product master data. A value indicating a date associated with the data segment is set as a value of the date data of the data segment. A value indicating the sale proceeds associated with the data segment is set as a value of the sale proceeds data of the data segment.

The sales transaction data according to this embodiment may be a table including each of the data segments as a record. The records of the shop master data according to this embodiment may include the values of the above-mentioned five attributes as values in respective columns.

The functionalities of social networking service (SNS) are implemented in the data storage server 10 according to this embodiment, and users can post posting data including a message on the data storage server 10. The posting data thus posted is placed in the time-line display area 24 in the time-line screen 20 shown in FIG. 2 as the posting information 28 in order of time.

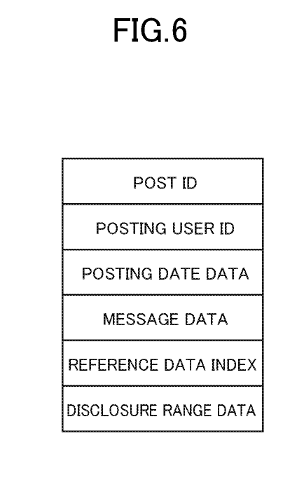

FIG. 6 is a diagram illustrating an example of data structure of the posting data according to this embodiment. As shown in FIG. 6, the posting data according to this embodiment includes a post ID, a posting user ID, posting date data, message data, a reference data index, and disclosure range data. The post ID is identification information of the posting data. The posting user ID is identification information of a user who posts the posting data. The posting date data indicates a date when the posting data is posted. The message data indicates a posted message. The reference data index is data indicating a name or an alias name of data referred to by the posting data. For example, the reference data index indicates a name or an alias name of data owned by the user who posts the posting data.

The disclosure range data indicates disclosure range of the posting data. In this embodiment, when a user posts posting data, the user can set a range of disclosing the posting data. For example, posting information 28 associated with a message to which “public” is set as a value of the disclosure range data is open to all users. For example, posting information associated with a message to which “friend” is set as a value of the disclosure range data is open to users registered as friends of the user who posts the post data. For example, posting information 28 associated with a message to which “private” is set as a value of the disclosure range data is not open to users other than the user who posts the post data.

In this embodiment, as shown in FIG. 2, the posting information 28 generated based on the posting data is placed in the time-line display area 24. Here, for example, a character string indicating a name of the user who posts the posting data is placed as a name character string A1. For example, a character string indicating a name associated with the posting user ID included in the posting data in the account data for managing the account of the user may be placed as the name character string A1. For example, time and date indicated by the posting date data included in the posting data is placed as a posting date character string A2. For example, a character string of a message indicated by the message data included in the posting data is placed as a message character string A3.

A name and an alias name indicated in a reference data index included in the posting data are placed as an other user-owned data index 30. In FIG. 2, alias names of the data associated with the reference data index are shown in parentheses.

In this embodiment, for example, a user B has weather data indicating weather in October 2017. The data storage server 10 stores such data. The other user-owned data index 30 in FIG. 2 indicates a name of the weather data is “weather 201710” and an alias name is “we201710.”

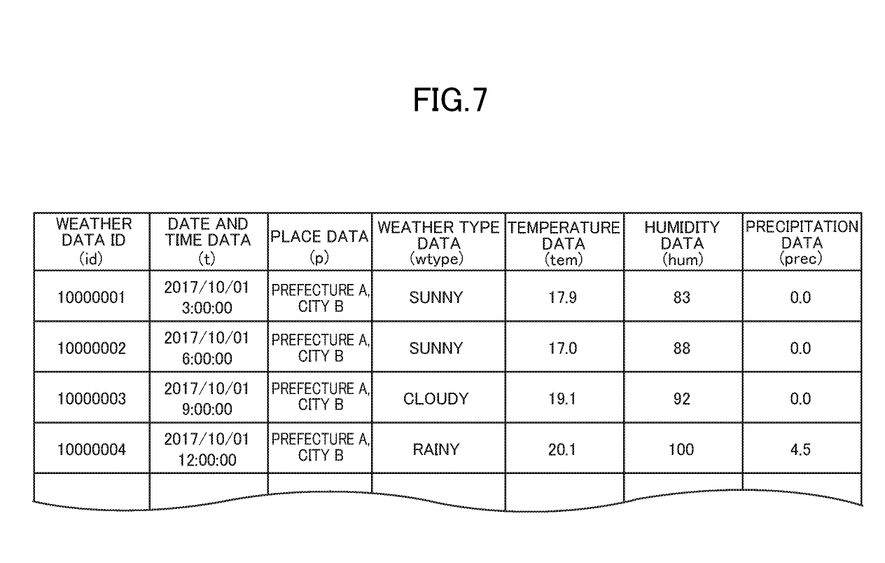

FIG. 7 is a diagram illustrating an example of the weather data according to this embodiment. The weather data shown in FIG. 7 indicates four data segments. A data segment of the weather data according to this embodiment is associated with weather at a place on a certain time and date. Here, in this embodiment, the weather indicates combinations of types of weather (e.g., sunny, cloudy, rainy, snowy), temperature, humidity, and precipitation, for example.

As shown in FIG. 7, a data segment of the weather data according to this embodiment includes seven attribute values, i.e., a weather data ID, date and time data, place data, weather type data, temperature data, humidity data, and precipitation data. In FIG. 7, alias names of the attributes are shown in parentheses. Specifically, for example, an alias name of the weather type data in the weather data is indicated as “wtype.”

For example, identification information of a data segment is set as a value of the weather data ID of the data segment in the weather data. A value indicating date and time associated with the data segment is set as a value of the date and time data of the data segment. A character string indicating a place associated with the data segment is set as a value of the place data of the data segment. A character string indicating a weather type associated with the data segment is set as a value of the weather type data of the data segment. A value indicating a temperature associated with the data segment is set as a value of the temperature data of the data segment. A value indicating humidity associated with the data segment is set as a value of the humidity data of the data segment. A value indicating precipitation associated with the data segment is set as a value of the precipitation data of the data segment.

The weather data according to this embodiment may be a table including each of the data segments as a record. The records of the weather data according to this embodiment may include the values of the above-mentioned seven attributes as values in respective columns.

In the area of the posting information 28, evaluation value information 32 indicating an evaluation value of joining the data which the user A owns to the weather data is also placed. Here, for example, when the evaluation of joining the data which the user A owns to the weather data is higher, a value indicated by the evaluation value information 32 may be set to greater. Further, joining each piece of the data which the user A owns to the weather data may be evaluated. An item of evaluation value information 32 indicating the value corresponding to the highest evaluation result may be placed in the posting information 28.

For example, useful findings regarding a correlation between weather and sales can be likely obtained by analyzing data joining the sales transaction data to the weather data. In this case, for example, a great value may be determined as an evaluation value indicating a value of joining the data which the user A owns to the weather data. In the example of FIG. 2, the evaluation value indicating a value of joining the data which the user A owns to the weather data is indicated as 80. An example of calculating an evaluation value shown in the evaluation value information 32 will be described later.

The posting information 28 also includes a disclosure range icon 34 in accordance with a value of the disclosure range data included in the posting data.

In this embodiment, all pieces of published posting information 28 may not necessarily be placed in the time-line display area 24. For example, the time-line display area 24 of the user terminal 12 of the user A only displays a piece of posting information 28 associated with data having an evaluation value of joining to the data of the user A equal to or more than a predetermined value.

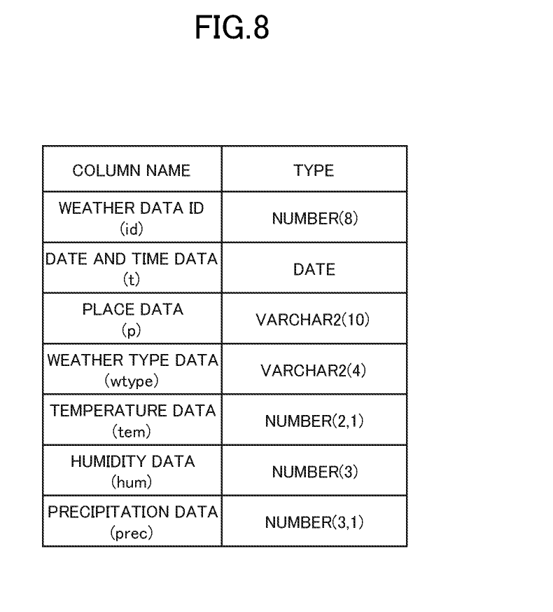

The posting information 28 includes a data item link 36 and a query link 38. For example, suppose that the user A performs an operation to select the data item link 36 included in the posting information 28. In this case, a display of the user terminal 12 of the user A displays a list of data items of the data, which is shown in the example of FIG. 8 and referred to by the reference data index included in the posting data corresponding to the posting information 28. The list of data items shown in FIG. 8 is displayed on the display of the user terminal 12 of the user A via a web browser, for example. The example of FIG. 8 shows names of columns included in the data segments of the weather data and data types of the columns.

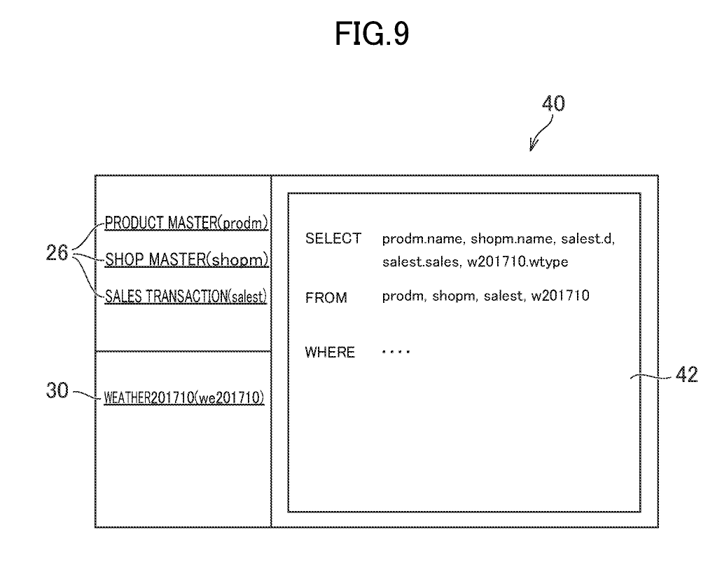

When the user A performs an operation to select the query link 38, a query execution screen 40 shown in FIG. 9 is displayed on the user terminal 12 of the user A. The query execution screen 40 shown in FIG. 9 is displayed on the display of the user terminal 12 of the user A via a web browser, for example. The query execution screen 40 shown in FIG. 9 includes the user-owned data indexes 26 and the other user-owned data index 30. Through a query form 42 included in the query execution screen 40, the user A can freely enter a query and display a result of the query. Using the query, for example, the user can access data associated with the user-owned data indexes 26 and the other user data index 30.

In this embodiment, data used in the query can be accessed by a name or an alias name of the data. In this embodiment, a column used in the query can be accessed by a name or an alias name of the column.

As described above, according to this embodiment, data which the user B owns is presented to the user A. The user A can use not only his/her own data but also the data which the user B, who is the other user, owns. For example, the user A can use not only his/her own data but also the data which the user B, who is the other user, owns so as to execute a query.

Here, data which some other user owns, and which has an evaluation value of joining to the data which the user A owns greater than the predetermined value, may be exclusively presented to the user A. In this way, for example, even if the number of users who use the data storage server 10 or the amount of data stored in the data storage server 10 is increased, it is possible to appropriately present data which some other user owns, and which has a high evaluation value of joining to the data which the user A owns, to the user A. Accordingly, the user A can readily find data which some other user owns, and which has a high evaluation value of joining to the data which the user A owns. This is expected to serve to greatly facilitate data distribution.

In the following, calculation of an evaluation value indicated by the evaluation value information 32 in this embodiment, that is, evaluation of a value obtained by joining a first data set to a second data set will be described.

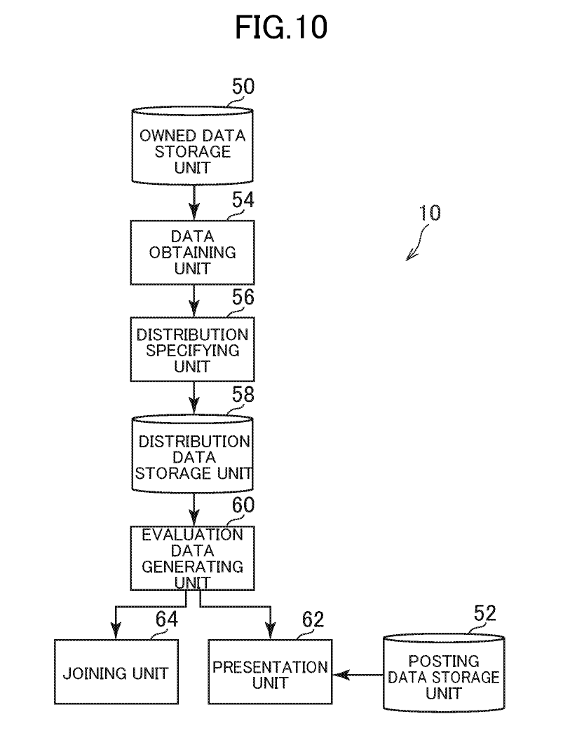

FIG. 10 is a functional block diagram showing an example of functions that relate to evaluation of a value obtained by joining the first data set to the second data set and are implemented in the data storage server 10 according to this embodiment. In this regard, all of the functions shown in FIG. 10 are not necessarily implemented in the data storage server 10 according to this embodiment, and a function other than the functions shown in FIG. 10 may be implemented in the data storage server 10.

As shown in FIG. 10, the data storage server 10 according to this embodiment functionally includes, for example, an owned data storage unit 50, a posting data storage unit 52, a data obtaining unit 54, a distribution specifying unit 56, a distribution data storage unit 58, an evaluation data generating unit 60, a presentation unit 62, and a joining unit 64. The owned data storage unit 50, the posting data storage unit 52, and the distribution data storage unit 58 are implemented mainly by the storage unit 10b. The data obtaining unit 54, the distribution specifying unit 56, the evaluation data generating unit 60, and the joining unit 64 are implemented mainly by the processor 10a. The presentation unit 62 is implemented mainly by the processor 10a and the communication unit 10c.

The above described functions may be implemented when a program that is installed in the data storage server 10, which is a computer, and includes a command for the above functions is executed by the processor 10a. The program may be provided to the data storage server 10 through a computer-readable information storage medium, such as an optical disc, a magnetic disk, a magnetic tape, a magneto-optical disk, and a flash memory, or the Internet.

The owned data storage unit 50 stores, for example, data owned by each of a plurality of users in this embodiment. For example, the owned data storage unit 50 stores, as described above, the user A's product master data, shop master data, and sales transaction data, and the user B's weather data.

In this embodiment, the posting data storage unit stores, for example, posting data for which the data structure is shown in FIG. 6.

In this embodiment, the data obtaining unit 54 obtains, for example, a first data set including a plurality of first type data segments in which a value of a first attribute is determined. The first data set may be a first table including each of the first type data segments as a first type record. The first type data segment may include the value of the first attribute as a value of the first column included in the first type record. The first data set may be data which a first user (e.g., here the user A) owns.

In this embodiment, the data obtaining unit 54 also obtains, for example, a second data set including a plurality of second type data segments in which a value of a second attribute is determined. The second data set may be a second table including each of the second type data segments as a second type record. The second type data segment may include the value of the second attribute as a value of the second column included in the second type record. The second data set may be data which a second user (e.g., here the user B) owns.

In this embodiment, for example, the distribution specifying unit 56 specifies a distribution of values of the first attributes in the first type data segments included in the first data set. Here, for example, a distribution of values of the respective attributes in the data segments included in the data which the user A owns may be specified. Here, for example, a histogram showing the distribution of the values of the first attributes in the first type data segments included in the first data set may be calculated. For example, a first feature amount vector indicating features of the distribution of the values of the first attributes in the first type data segments included in the first data set may be calculated.

In this embodiment, for example, the distribution specifying unit 56 specifies a distribution of values of the second attributes in the second type data segments included in the second data set. Here, for example, a distribution of values of the respective attributes in the data segments included in the data which the user B owns may be specified. Here, for example, a histogram showing the distribution of the values of the second attributes in the second type data segments included in the second data set may be calculated. For example, a second feature amount vector indicating features of the distribution of the values of the second attributes in the second type data segments included in the second data set may be calculated.

In this embodiment, for example, the distribution data storage unit 58 stores data indicating a distribution of the values of the first attributes in the first type data segments included in the first data set calculated by the distribution specifying unit 56. In this embodiment, for example, the distribution data storage unit 58 stores data indicating the distribution of the values of the second attributes in the second type data segments included in the second data set calculated by the distribution specifying unit 56. The distribution data storage unit 58 may store the first feature amount vector and the second feature amount vector.

In this embodiment, for example, the evaluation data generating unit 60 generates evaluation data indicating an evaluation value of joining the first data set to the second data set based on the specified distribution of the values of the first attributes and the specified distribution of the values of the second attributes. Here, for example, the evaluation data indicating the evaluation value of joining the first data set to the second data set may be generated based on the generated first feature amount vector and the generated second feature amount vector.

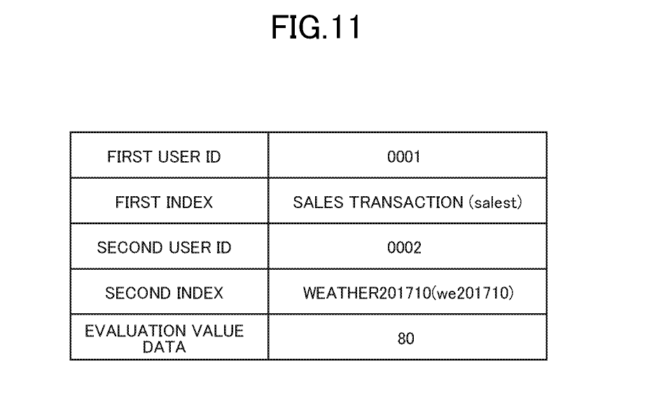

FIG. 11 is a diagram illustrating an example of the evaluation data according to this embodiment. For example, the evaluation value information 32 according to the evaluation data shown in FIG. 11 may be placed as a part of the posting information 28 shown in FIG. 2. As shown in FIG. 11, the evaluation data includes a first user ID, a first index, a second user ID, a second index, and evaluation value data. The first user ID is identification information of a user who owns the first data set. Here, for example, the identification information of the user A is 0001. The first index is data indicating a name and an alias name of the first data set. FIG. 11 shows a name and an alias name of the sales transaction data, which is the first data set, as the first index. The second user ID is identification information of a user who owns the second data set. Here, for example, the identification information of the user B is 0002. The second index is data indicating a name and an alias name of the second data set. FIG. 11 shows a name and an alias name of the weather data, which is the second data set, as the second index. The evaluation value of joining the first data set to the second data set is set as a value of the evaluation value data included in the evaluation data. FIG. 11 shows that the evaluation value of joining the sales transaction data to the weather data is 80.

For example, suppose that a data type of the first attribute of the first data set is the same as a data type of the second attribute of the second data set. In this case, the evaluation data generating unit 60 may generate evaluation data indicating an evaluation value of generating data by joining the first attribute to the second attribute. Here, when the accuracy and the scale are different but the data type is the same, the evaluation data may be generated.

Specifically, for example, suppose that a data type of the date data of the sales transaction data and a data type of the date data of the weather data is a date type. For example, in this case, evaluation data indicating an evaluation value of generating a table in which the sales transaction data and the weather data are joined by joining the date data of the sales transaction data to the date data of the weather data may be generated. In this way, the evaluation data generating unit 60 may generate evaluation data indicating an evaluation value of generating a table in which the first table and the second table are joined by joining the first column to the second column.

In this embodiment, for example, the presentation unit 62 presents the second data set to the user who owns the first data set. When the evaluation value indicated by the generated evaluation data satisfies a predetermined condition, the presentation unit 62 may present the second data set to the user who owns the first data set. For example, when the evaluation value indicated by the evaluation data is equal to or more than a predetermined value (e.g., 70), the second data set may be presented to the user who owns the first data set.

Here, the first user may be able to access only the data presented to the user who owns the first data set. For example, if the presentation unit 62 presents the weather data to the user A, the user A may be able to access the weather data by the query form 42, as described above.

The presentation unit 62 may generate a time-line screen 20 based on the posting data stored in the posting data storage unit 52. Here, the presentation unit 62 may specify posting data including a value of the second index included in the evaluation data where the evaluation value indicated by the evaluation value data is equal to or more than a predetermined value (e.g., 70) as a value of the reference data index data. The presentation unit 62 may generate a time-line screen 20 based on the specified posting data. In this case, a time-line screen 20, on which the posting information 28 that includes a second index included in the evaluation data where the evaluation value indicated by the evaluation value data is equal to or more than a predetermined value (e.g., 70) as the other user data index 30 is placed, is generated. The time-line screen 20 then may be sent to a user terminal 12 of the user A. In this case, the time-line screen 20 is displayed on a display of the user terminal 12 of the user A.

In this embodiment, for example, the joining unit 64 generates a third data set by joining the first data set to the second data set. In a case where the evaluation value indicated by the generated evaluation data satisfies a predetermined condition, the joining unit 64 may generate the third data set by joining the first data set to the second data set. For example, in a case where the evaluation value indicated by the generated evaluation data is equal to or more than the predetermined value (e.g., 70), the third data set may be generated by joining the first data set to the second data set.

For example, suppose that a data type of the first attribute of the first data set is the same as a data type of the second attribute of the second data set. Further, suppose that the evaluation value of joining the first data set to the second data set is equal to or more than the predetermined value. In this case, the joining unit 64 may generate the third data set by joining the first data set to the second data set using the first attribute of the first data set and the second attribute of the second data set as keys. Here, when the accuracy and the scale are different but the data type is the same, the first data set and the second data set may be joined.

Specifically, for example, the joining unit 64 may generate sales analysis data, which is a table joining the sales transaction data to the weather data, by using a value of the date data of the sales transaction data and a value of the date data included in the weather data as keys. Here, the joining unit 64 may store the generated sales analysis data in the data storage server 10. Other methods for joining data may also be employed. For example, if both the first data set and the second data set are tables, the first data set and the second data set may be joined by cross join, inner join, or outer join so as to generate a table, which is the third data set.

Doing as above enables to access the third data set without joining the first data set to the second data set by a query. As such, it is possible to access the third data set generated by the joining unit 64 in a shorter time than when accessing the third data set after the first data set and the second data set are joined.

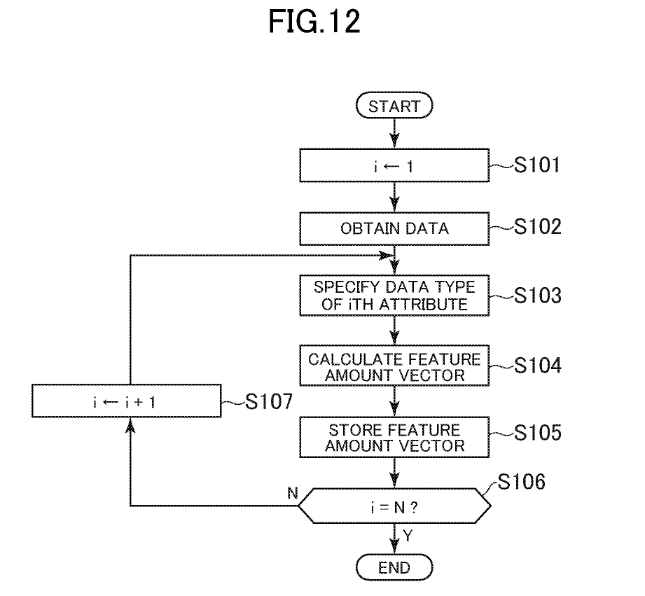

Referring to a flow chart shown in FIG. 12, an example of processing of generating a feature amount vector for each of the attributes included in data, which is executed by the data storage server 10 according to this embodiment, will be described. In this example of the processing, suppose that the number of attributes included in the data is N.

First, the data obtaining unit 54 sets 1 as a value of a variable i (S101).

The data obtaining unit 54 then obtains a piece of data, from which a feature amount vector is generated, from the owned data storage unit 50 (S102).

The distribution specifying unit 56 specifies a data type of the ith attribute of the data obtained in S102 (S103).

The distribution specifying unit 56 calculates a feature amount vector according to the data type, which is specified in S103, of the ith attribute of the data obtained in S102 (S104).

The distribution specifying unit 56 stores the feature amount vector calculated in S104 in the distribution data storage unit 58 (S105). In this case, in this example of the processing, the feature amount vector is stored in the distribution data storage unit in association with a combination of identification information of the data obtained in S102 and identification information of the ith column of the data.

Subsequently, the data obtaining unit 54 determines whether a value of the variable i is N (S106). If the value of the variable i is not N (S106: N), the data obtaining unit 54 adds 1 to the variable i (S107), and the processing returns to S103.

If the value of the variable i is N (S106 :Y), the processing in this example terminates.

In this embodiment, for example, the processing described above is executed for the product master data, the shop master data, the sales transaction data, each owned by the user A, and for the weather data owned by the user B. That is, a feature amount vector of an attribute included in each of these data items is stored in the distribution data storage unit 58.

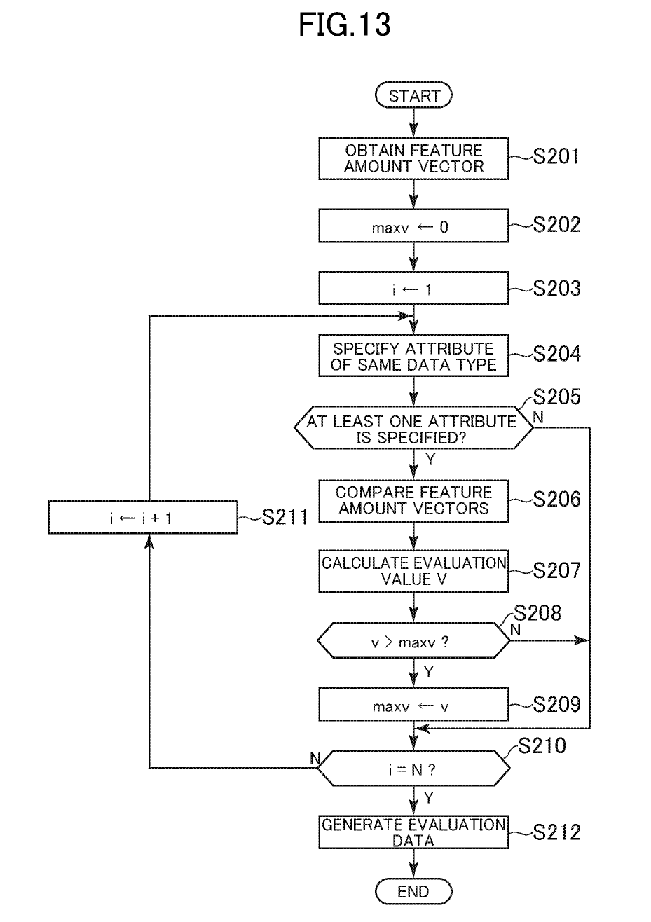

Next, referring to a flow chart in FIG. 13, an example of processing of generating evaluation data indicating an evaluation value of joining the first data set to the second data set, which is executed in the data storage server 10 according to this embodiment, will be described. In this example of the processing, suppose that the number of attributes included in the first data set is N.

The evaluation data generating unit 60 obtains a feature amount vector of each attribute included in the first data set and a feature amount vector of each attribute included in the second data set from the distribution data storage unit 58 (S201).

The evaluation data generating unit 60 sets 0 for a value of a variable maxv (S202).

The evaluation data generating unit 60 sets 1 for a value of a variable i (S203).

The evaluation data generating unit 60 specifies, from the attributes included in the second data set, an attribute that has the same data type as the ith attribute of the first data set (S204).

The evaluation data generating unit 60 determines whether at least one attribute has been specified in S204 (S205).

If it is determined that at least one attribute has been specified (S205: Y), the evaluation data generating unit 60 compares the feature amount vector of the ith attribute of the first data set with each of the feature amount vectors of the attributes included in the second data set specified in S204 (S206). Here, a value indicating similarity or a value indicating a distance between the two feature amount vectors is calculated by using known methods, for example. Here, for example, when the two feature amount vectors are more similar to each other, a value indicating the similarity may be larger. Further, when the two feature amount vectors are more similar to each other, a value indicating the distance may be smaller.

The evaluation data generating unit 60 calculates an evaluation value v according to the result of the comparison in S206 (S207). For example, an evaluation value v, which is corresponding to the maximum value of the values indicating similarities calculated for respective attributes that are included in the second data set and specified in S204, may be calculated. In this case, for example, a value obtained by normalizing the maximum value of the values indicating the similarities to be equal to or more than 0 and equal to or less than 100 may be calculated as an evaluation value v. For example, an evaluation value v, which is corresponding to the minimum value of the values indicating distances calculated for respective attributes that are included in the second data set and specified in S204, may be calculated. Here, for example, a value obtained by normalizing the inverse of the minimum value of the values indicating the distances to be equal to or more than 0 and equal to or less than 100 may be calculated as an evaluation value v.

The evaluation data generating unit 60 determines whether the evaluation value v calculated in S207 is greater than the variable maxv (S208).

If the evaluation value v is greater than the variable maxv (S208: Y), the evaluation data generating unit 60 updates the variable maxv to the evaluation value v (S209).

If the evaluation value v is equal to or less than the variable maxv (S208: N), or, if the processing of S209 is finished, the evaluation data generating unit 60 determines whether the variable i is N (S210). In a case where it is determined that an attribute is not specified in S205 (S205: N), the evaluation data generating unit 60 also determines whether the variable i is N (S210).

In a case where the variable i is not N (S210: N), the evaluation data generating unit 60 adds 1 to the variable i (S211), and returns to the processing of S204.

In a case where the variable i is N (S210: Y), the evaluation data generating unit 60 generates evaluation data that includes the value of the variable maxv as the value of the evaluation value data (S212), and the processing in this example terminates. In this case, identification information of the user who owns the first data set is set to the first user ID of the generated evaluation data. Further, a name and an alias name of the first data set are set as the value of the first index of the generated evaluation data. Further, identification information of the user who owns the second data set is set to the second user ID of the generated evaluation data. Further, a name and an alias name of the second data set are set to the value of the second index of the generated evaluation data.

In S204, in addition to the attribute that has the same data type as the ith attribute of the first data set, an attribute connectable to the ith attribute of the first data set may be specified in the attributes included in the second data set. For example, an attribute to have the same data type as the ith attribute of the first data set by casting the ith attribute of the first data set may be specified from the attributes included in the second data set.

The attribute to have the same data type as the ith attribute of the first data set by casting the ith attribute of the first data set may be understated with respect to the values indicating the similarities and the distances between the feature amount vectors. For example, the evaluation value v of the attribute to have the same data type as the ith attribute of the first data set by casting the ith attribute of the first data set may be a value obtained by multiplying the evaluation value v calculated in S207 by a coefficient equal to or more than 0 and less than 1 (e.g., 0.5). Specifically, for example, a value obtained by multiplying the value, which is obtained by normalizing the maximum value of the values indicating the similarities to be equal to or more than 0 and equal to or less than 100, by a coefficient equal to or more than 0 and less than 1 may be calculated as an evaluation value v. Alternatively, for example, a value obtained by multiplying the value, which is obtained by normalizing the inverse of the minimum value of the values indicating the distances to be equal to or more than 0 and equal to or less than 100, by a coefficient equal to or more than 0 and less than 1 may be calculated as an evaluation value v.

For example, the evaluation data generating unit 60 may generate evaluation data indicating an evaluation value of joining the data set (e.g., the sales analysis data mentioned above) generated by the joining unit 64 to another data set. The joining unit 64 may generate a data set by joining the data (e.g., the sales analysis data mentioned above) generated by the joining unit 64 to another data set.

The present invention is not to be limited to the above described embodiment.

The first data set and the second data set may not be a table.

The particular character strings and numerical values in the above description and the particular character strings and numerical values in the drawings are examples, and the present invention is not limited to these particular character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A joint data evaluation system, comprising:
at least one processor; and
at least one memory device that stores a plurality of instructions, which when executed by the at least one processor, cause the at least one processor to:
obtain a first data set including a plurality of first type data segments, each of the first type data segments including a value of a first attribute;
obtain a second data set including a plurality of second type data segments, each of the second type data segments including a value of a second attribute;
specify a distribution of the values of the first attributes in the plurality of first type data segments included in the first data set;
specify a distribution of the values of the second attributes in the plurality of second type data segments included in the second data set;
generate evaluation data indicating an evaluation value of joining the first data set to the second data set based on the specified distribution of the values of the first attributes and the specified distribution of the values of the second attributes.

2. The joint data evaluation system according to claim 1, wherein the at least one memory device that stores the plurality of instructions further causes the at least one processor to:
calculate a first feature amount vector indicating a feature of the distribution of the values of the first attributes in the plurality of first type data segments included in the first data set;
the second distribution specifying means calculates a second feature amount vector indicating a feature of the distribution of the values of the second attributes in the plurality of second type data segments included in the second data set;
the evaluation data generating means generates evaluation data indicating an evaluation value of joining the first data set to the second data set based on the generated first feature amount vector and the generated second feature amount vector.

3. The joint data evaluation system according to claim 1, wherein the at least one memory device that stores the plurality of instructions further causes the at least one processor to:
obtain the first data owned by a first user, and
obtain the second data owned by a second user.

4. The joint data evaluation system according to claim 3, wherein the at least one memory device that stores the plurality of instructions further causes the at least one processor to:
present the second data set to the user who owns the first data set in a case where the evaluation value indicated by the generated evaluation data satisfies a predetermined condition.

5. The joint data evaluation system according to claim 1, wherein the at least one memory device that stores the plurality of instructions further causes the at least one processor to:
generate a third data set by joining the first data set to the second data set in a case where the evaluation value indicated by the generated evaluation data satisfies a predetermined condition.

6. The joint data evaluation system according to claim 1, wherein
the first data set is a first table that includes each of the plurality of first type data segments as a first type record,
the first type record includes the value of the first attribute as a value of a first column in the first type record,
the second data set is a second table that includes each of the plurality of second type data segments as a second type record,
the second type record includes the value of the second attribute as a value of a second column in the second type record, and
the at least one memory device that stores the plurality of instructions further causes the at least one processor to generate evaluation data indicating an evaluation value of generating a table in which the first table and the second table are joined by joining the first column to the second column.

7. A joint data evaluation method, comprising the steps of:
obtaining a first data set including a plurality of first type data segments, each of the first type data segments including a value of a first attribute;
obtaining a second data set including a plurality of second type data segments, each of the second type data segments including a value of a second attribute;
specifying a distribution of the values of the first attributes in the plurality of first type data segments included in the first data set;
specifying a distribution of the values of the second attributes in the plurality of second type data segments included in the second data set;
generating evaluation data indicating an evaluation value of joining the first data set to the second data set based on the specified distribution of the values of the first attributes and the specified distribution of the values of the second attributes.

8. A non-transitory computer readable storage medium having stored thereon a program for causing at least one processor to:
obtain a first data set including a plurality of first type data segments, each of the first type data segments including a value of a first attribute;
obtain a second data set including a plurality of second type data segments, each of the second type data segments including a value of a second attribute;
specify a distribution of the values of the first attributes in the plurality of first type data segments included in the first data set;
specify a distribution of the values of the second attributes in the plurality of second type data segments included in the second data set;
generate evaluation data indicating an evaluation value of joining the first data set to the second data set based on the specified distribution of the values of the first attributes and the specified distribution of the values of the second attributes.
